(19) United States
(12) Patent Application Publication
(10) Pub. No.: US 2011/0285685 A1
(43) Pub. Date: Nov. 24, 2011

(54) Light emitting element driver and display device

(75) Inventors: Takahiro Naito, Tokyo (JP); Tatsuki Nishino, Tokyo (JP); Takuro Akiyama, Kanagawa (JP); Yasushi Katayama, Kanagawa (JP)

(73) Assignee: Sony Corporation, Tokyo (JP)

(21) Appl. No.: 13/064,112

(22) Filed: Mar. 7, 2011

(30) Foreign Application Priority Data
May 19, 2010 (JP) 2010-115237

(51) Int. Cl. G06F 3/038; H05B 37/02

(52) U.S. Cl. 345/211; 315/297

(57) ABSTRACT

Disclosed herein is a light-emitting element driver including: a light-emitting section; a power supply section; a switching section; a constant current circuit or resistor; and a control circuit.

### BACKGROUND OF THE INVENTION

1. Field of the Invention

The present invention relates to a driver of a light-emitting element such as light-emitting diode (LED) adapted to emit light at the luminance commensurate with the current flowing therethrough and a display device having, for example, a non-luminous transmissive display section using the driver.

2. Description of the Related Art

Light-emitting diodes (LEDs) are used to replace a CCFL (Cold Cathode Fluorescent Lamp) as a light source of the backlight in a liquid crystal panel.

The technique of obtaining white by individually using the three primary colors, i.e., red, green and blue LEDs, and optically synthesizing or additively mixing these primary colors in particular is used for television purposes because of its ease in achieving color balance. On the other hand, recent years have witnessed increasing improvement of white LEDs in color rendering, allowing white LEDs to find wide application in television.

The luminance of an LED basically changes according to the current flow. Further, the forward voltage changes due to individual variation and temperature.

Therefore, when used as a backlight of a liquid crystal panel (e.g., LCD), the LED driver must have a constant current characteristic to provide a constant and uniform luminance.

On the other hand, a driver using the PWM control method is known to stably adjust the luminance over a wide dynamic range. The PWM control method turns ON and OFF the current flowing through the LED at constant timings, adjusting the luminance based on the ratio between the ON and OFF periods.

One approach to achieving this method is to insert a switching element in series with the LED and turn ON and OFF the switching element at given timings (refer, for example, to Japanese Patent Laid-Open No. 2001-272938).

Another known approach is to turn ON and OFF the switching element connected in series with the LED with a lighting-up signal, thus performing PWM control over the switching transistor of a switching power supply section such as boost chopper.

FIG. 1 is a diagram for describing a related technique of a light-emitting element (LED) driver.

This LED driver 1 includes a boost chopper switching power supply section 2, light-emitting section 3, switching section 4, constant current circuit (or resistor) 5 and control circuit 6. The light emitting section 3 includes an LED array and serves as a load. The LED array has a plurality of LEDs connected in series.

The switching power supply section 2 includes a constant voltage source V21, inductor L21, diode D21, power storage capacitor C21, switching transistor SW21, current detection resistor element R21 and nodes ND21 to ND23.

The inductor L21 has its one end connected to the constant voltage source V21 at a voltage VDD and its other end connected to the node ND21. The diode D21 has its anode connected to the node ND21 and its cathode connected to the node ND22. The capacitor C21 has its one terminal (electrode) connected to the node ND22 and its other terminal (electrode) connected to a reference potential VSS (e.g., ground potential).

The node ND22 is connected as a voltage output node of the switching power supply section 2 to one end of the light emitting section 3 that serves as a load.

The switching transistor SW21 is formed with an NMOS transistor which is, for example, an n-channel field effect transistor. The switching transistor SW21 has its drain connected to the node ND21 and its source connected to one end of the resistor element R21. The resistor element R21 has its other end connected to the reference potential VSS.

In the switching power supply section 2 configured as described above, the switching transistor SW21 is controlled to turn ON and OFF by a PWM-controlled pulse signal of the control circuit 6, thus boosting the voltage VDD of the constant voltage source V21 and supplying the boosted voltage to one end of the light-emitting section 3.

The light-emitting section 3 is formed with a plurality of LEDs 3-1 to 3-n connected in series.

Of the plurality of LEDs 3-1 to 3-n connected in series, the LED 3-1 at one end has its anode connected to the voltage output node ND22 of the switching power supply section 2, and the LED 3-n at the other end has its cathode connected to a terminal ‘a’ of the switching section 4.

It should be noted that the light-emitting section 3 is not limited to being formed with a plurality of LEDs, but may be formed with a single LED.

The switching section 4 has its other terminal ‘b’ connected to the constant current circuit (or resistor) 5.

The constant current circuit (or resistor) 5 is connected to the reference potential VSS.

The switching section 4 is maintained ON while an LED lighting-up signal LO in a pulse form is active high. At this time, a current ILED flows through the light-emitting section 3 that receives a supply voltage Vo from the switching power supply section 2, causing the LEDs 3-1 to 3-n to be lit.

The, switching section 4 is maintained OFF while the LED lighting-up signal LO is inactive low. At this time, the current ILED does not flow through the light-emitting section 3 that receives the supply voltage Vo from the switching power supply section 2, causing the LEDs 3-1 to 3-n to be unlit.

While the switching section 4 is ON, a voltage Vs of a connection node ND1 between the switching section 4 and constant current circuit 5 is basically equal to the voltage obtained by subtracting a sum ΣVf (=VF) of forward voltages Vf of all the LEDs 3-1 to 3-n of the light-emitting section 3 from the supply voltage Vo of the switching power supply section 2.

This voltage does not take into consideration the voltage drop across the switching section 4.

If the switching section 4 is formed with a field effect transistor (FET), the voltage of the node ND1 is equal to the voltage obtained by subtracting the sum VF of the forward voltages Vf of all the LEDs 3-1 to 3-n of the light-emitting section 3 and a drain-to-source voltage Vds of the FET from the supply voltage Vo.

The control circuit 6 includes an error amplifier 61, comparator 62, pulse output flip-flop (FF) 63, clock generator 64, driver 65, reference voltage source V61, holding capacitor C61 and terminals T1, T2 and T3.

The comparator 62, FF 63 and clock generator 64 make up a pulse converter 66.

The terminal T1 is connected to the connection node ND1 between the switching section 4 and constant current circuit 5. The terminal T2 is connected to the node ND23 of the switching power supply section 2. The terminal T3 is connected to the gate of the switching transistor SW21.

The error amplifier 61 has its non-inverted input terminal (+) connected to the reference voltage source V61 and its inverted input terminal (−) connected to the terminal T1 to which the voltage Vs of the node ND1 is supplied.

The error amplifier 61 amplifies the voltage difference between the voltage Vs of the node ND1 and a reference voltage Vref and outputs a voltage Verr. This voltage Verr is held by the capacitor C61.

The comparator 62 has its non-inverted input terminal (+) connected to the terminal T2 and its inverted input terminal (−) connected to the output of the error amplifier 61. The terminal T2 is connected to the node ND23 of the switching power supply section 2

The comparator 62 compares the error voltage Verr and a voltage (voltage obtained by converting the current Is with the resistor element R21) VN23 of the node ND23 and outputs the comparison result to the FF 63.

The comparator 62 outputs a low level signal when the voltage VN23 of the node ND23 is lower than the error voltage Verr and a high level signal when the voltage VN23 is higher than the error voltage Verr.

The FF 63 includes a set-reset (RS) FF.

The FF 63 is cleared when the LED lighting-up signal LO is inactive low. When the LED lighting-up signal LO is active high, the FF 63 outputs a pulse from its terminal Q according to the level of a clock CLK supplied to its set terminal S and the level of the output signal from the comparator 62 supplied to its reset terminal RT.

As a result, the FF 63 outputs, to the driver 65, a signal PLS having a pulse width commensurate with the difference between the voltage Vs of the node ND1 and the reference voltage Vref.

This pulse signal PLS is supplied to the gate of the switching transistor SW21 via the driver 65, allowing for the switching power supply section 2 to perform voltage boosting by controlling the switching transistor SW21 to turn ON and OFF.

### SUMMARY OF THE INVENTION

As described above, in the LED driver 1 shown in FIG. 1, the current flowing through the inductor L21 of the switching power supply section 2 is controlled while the LED lighting-up signal LO is active high, in other words, during a period of time from the leading to trailing edges of the LED lighting-up signal LO.

FIGS. 2A to 2C are diagrams illustrating major waveforms of the switching power supply section of the LED driver 1 shown in FIG. 1 during control.

FIG. 2A illustrates the waveform of the LED lighting-up signal LO, FIG. 2B the waveforms of the error voltage Verr and the current Is of the node ND23, and FIG. 2C the waveform of a current IL flowing through the inductor L21 together with its peak envelope waveform.

As described above, during control of the switching power supply section 2 of the LED driver 1 shown in FIG. 1, the current flowing through the inductor L21 of the same section 2 is controlled from the leading to trailing edges of the LED lighting-up signal LO.

In this case, the input current changes significantly (steeply) at the leading and trailing edges of the LED lighting-up signal LO as shown by reference numerals RP and FP in FIGS. 2A to 2C.

That is, in the LED driver 1 shown in FIG. 1, the current IL flowing through the inductor L21 changes significantly immediately after the LEDs of the light-emitting section 3 light up and when the LEDs go out.

In general, magnetic components such as transformers and choke coils, and capacitors used for power supplies vibrate in principle at the frequency of the current or voltage applied thereto.

Therefore, it is likely that audible abnormal noise may be often produced by these components whose current IL changes significantly as in the LED driver 1 shown in FIG. 1.

Further, these components may heat up abnormally due to so-called rush current.

It is an aim of the present invention to provide a light-emitting element drive circuit and a display device having the same capable of minimizing the change in current flowing through magnetic and other components of the power supply so as to keep abnormal noise to a minimum and prevent abnormal heating.

A light-emitting element driver according to a first mode of the present invention includes a light-emitting section, power supply section, switching section, constant current circuit and control circuit. The light-emitting section includes at least one light-emitting element adapted to emit light at the luminance commensurate with the current flowing therethrough. The power supply section is adjustable in output voltage according to the signal fed to the control terminal of a switching element and supplies an output voltage to one end of the light-emitting section. The switching section is connected between each of other ends of the light-emitting section and a reference potential and controlled to conduct or block current by a lighting-up signal in a pulse form. The constant current circuit is connected between the other end of the light-emitting section and the reference potential so as to be in series with the switching section. The control circuit obtains an error voltage between a connection terminal voltage between the switching section and constant current circuit and the preset reference voltage and outputs, to the control terminal of the switching element, a signal having a pulse width causing a current proportional to the error voltage to flow through the switching element. At least either during a soft start period starting from the leading edge of the lighting-up signal or during a soft end period starting from the trailing edge of the lighting-up signal, the control circuit outputs, to the control terminal of the switching element, a signal having a pulse width causing a current proportional to a soft voltage rather than the error voltage to flow through the switching element. The soft voltage increases from the reference potential with time or decreases from the error voltage with time.

A display device according to a second mode of the present invention includes a transmissive display section, an illumination unit and light-emitting element driver. The illumination unit includes light-emitting section including at least one light-emitting element adapted to emit light at the luminance commensurate with the current flowing therethrough. The illumination unit is adapted to irradiate the transmissive display section with emitted light. The light-emitting element driver is adapted to drive the light-emitting element of the light-emitting section. The light-emitting element driver includes a power supply section, switching section, constant current circuit and control circuit. The power supply section is adjustable in output voltage according to the signal fed to the control terminal of a switching element and supplies an output voltage to one end of the light-emitting section. The switching section is connected between each of other ends of the light-emitting section and a reference potential and controlled to conduct or block current by a lighting-up signal in a pulse form. The constant current circuit is connected between the other end of the light-emitting section and the reference potential so as to be in series with the switching section. The control circuit obtains an error voltage between a connection terminal voltage between the switching section and constant current circuit and the preset reference voltage and outputs, to the control terminal of the switching element, a signal having a pulse width causing a current proportional to the error voltage to flow through the switching element. At least either during a soft start period starting from the leading edge of the lighting-up signal or during a soft end period starting from the trailing edge of the lighting-up signal, the control circuit outputs, to the control terminal of the switching element, a signal having a pulse width causing a current proportional to a soft voltage rather than the error voltage to flow through the switching element. The soft voltage increases from the reference potential with time or decreases from the error voltage with time.

The present invention minimizes the change in current flowing through magnetic and other components of the power supply, thus keeping abnormal noise to a minimum and preventing abnormal heating.

### BRIEF DESCRIPTION OF THE DRAWINGS

FIG. 1 is a diagram for describing a related technique of a light-emitting element (LED) driver;

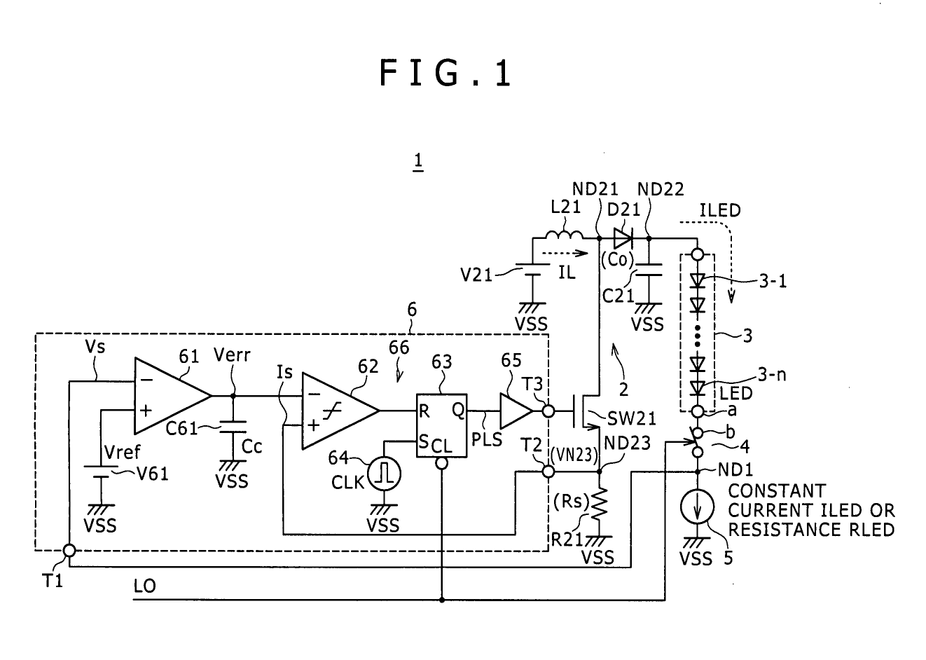

FIGS. 2A to 2C are diagrams illustrating major waveforms of a switching power supply section of an LED driver shown in FIG. 1 during control;

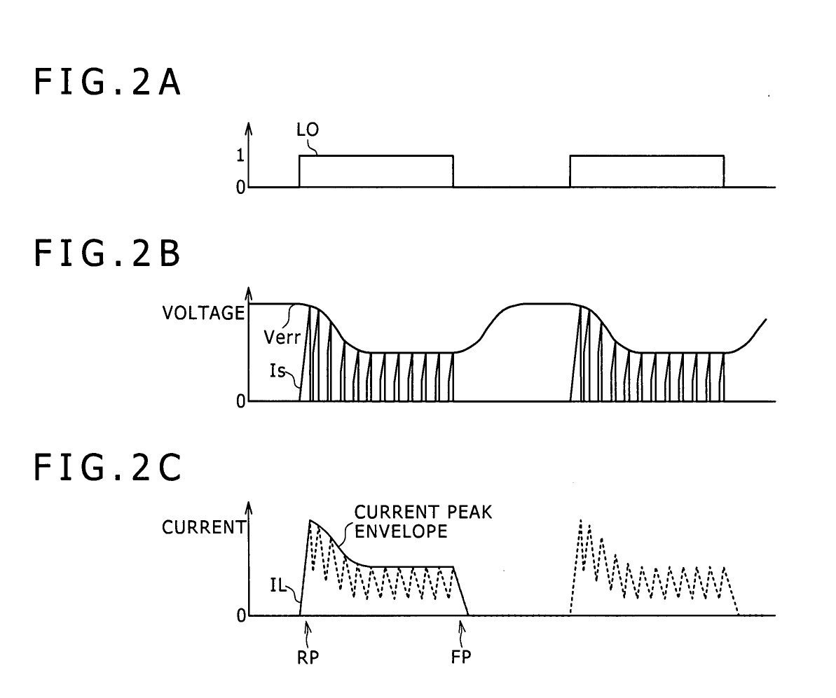

FIG. 3 is a block diagram illustrating a configuration example of a light-emitting element (LED) driver according to a first embodiment of the present invention;

FIG. 4 is a circuit diagram illustrating a configuration example of the light-emitting element (LED) driver according to the first embodiment of the present invention;

FIGS. 5A to 5C are diagrams illustrating major waveforms of the switching power supply section of the LED driver according to the present embodiment during control;

FIG. 6 is a diagram illustrating a configuration example of a soft switching circuit according to the present embodiment;

FIG. 7 is a block diagram illustrating a configuration example of the light-emitting element (LED) driver according to a second embodiment of the present invention;

FIG. 8 is a block diagram illustrating a configuration example of a liquid crystal display device according to a third embodiment of the present invention; and

FIG. 9 is a diagram illustrating a configuration example of a transmissive LCD panel.

### DETAILED DESCRIPTION OF THE PREFERRED EMBODIMENTS

A description will be given below of the preferred embodiments of the present invention with reference to the accompanying drawings.

It should be noted that the description will be given in the following order:
1. First embodiment (first configuration example of the light-emitting element (LED) driver)
2. Second embodiment (second configuration example of the light-emitting element (LED) driver)
3. Third embodiment (configuration example of the display device)

### 1. First Embodiment

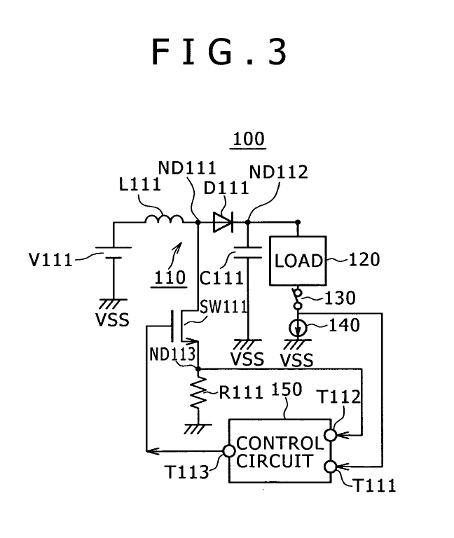

FIG. 3 is a block diagram illustrating a configuration example of a light-emitting element (LED) driver according to a first embodiment of the present invention.

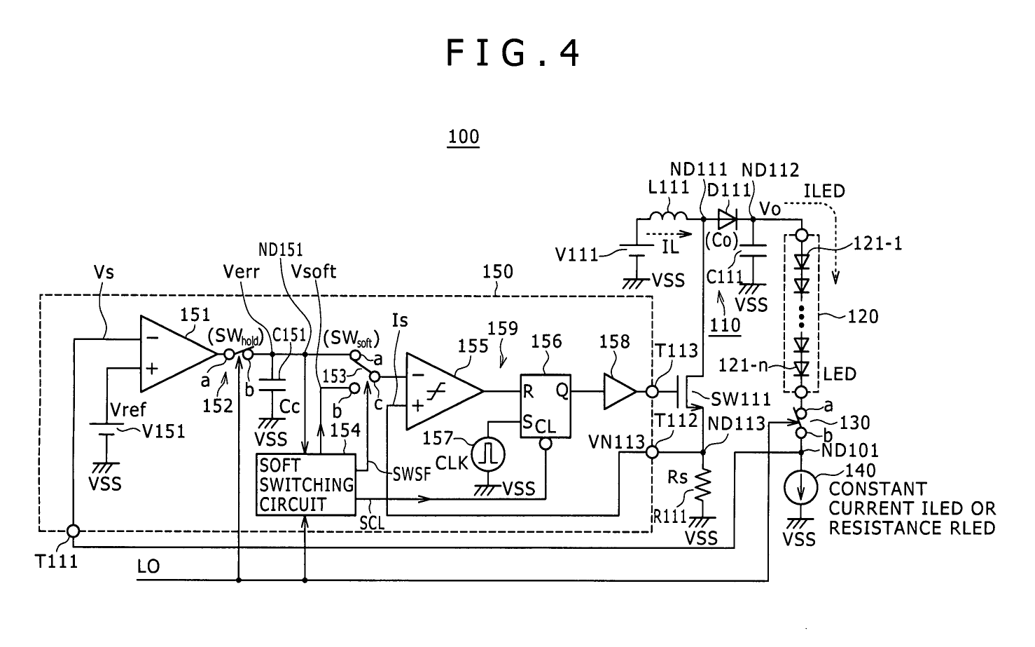

FIG. 4 is a circuit diagram illustrating a configuration example of the light-emitting element (LED) driver according to the first embodiment of the present invention.

In the present embodiment, LEDs are used as electro-optic elements to be driven whose luminance changes according to the current flowing therethrough.

An LED driver 100 shown in FIGS. 3 and 4 includes a boost chopper switching power supply section 110, light-emitting section 120, switching section 130, constant current circuit 140 and control circuit 150. The light-emitting section 120 serves as a load.

The switching power supply section 110 includes a constant voltage source V111, inductor L111, diode D111, power storage capacitor C111, switching transistor SW111, current detection resistor element R111 and nodes ND111 to ND113.

The inductor L111 has its one end connected to the constant voltage source V111 at the voltage VDD and its other end connected to the node ND111. The diode D111 has its anode connected to the node ND111 and its cathode connected to the node ND112. The capacitor C111 has its one terminal (electrode) connected to the node ND112 and its other terminal (electrode) connected to the reference potential VSS (e.g., ground potential).

The node ND112 is connected as a voltage output node of the switching power supply section 110 to one end of the light emitting section 120 that serves as a load.

The switching transistor SW111 is formed with an NMOS transistor which is, for example, an n-channel field effect transistor. The switching transistor SW111 has its drain connected to the node ND111 and its source connected to one end of the resistor element R111. The resistor element R111 has its other end connected to the reference potential VSS.

In the switching power supply section 110 configured as described above, the switching transistor SW111 is controlled to turn ON and OFF by a PWM-controlled pulse signal of the control circuit 150, thus boosting the voltage VDD of the constant voltage source V111 and supplying the boosted voltage to one end of the light-emitting section 120.

The light-emitting section 120 is formed with an LED array that has a plurality of LEDs 121-1 to 121-n connected in series.

Of the plurality of LEDs 121-1 to 121-n connected in series, the LED 121-1 at one end has its anode connected to the voltage output node ND112 of the switching power supply section 110, and the LED 121-n at the other end has its cathode connected to the terminal ‘a’ of the switching section 130.

It should be noted that the light-emitting section 120 is not limited to being formed with a plurality of LEDs, but may be formed with a single LED.

The switching section 130 has its other terminal ‘b’ connected to the constant current circuit 140. The constant current circuit 140 is connected to the reference potential VSS.

The switching section 130 is maintained ON while the LED lighting-up signal LO in a pulse form is active high. At this time, the current ILED flows through the light-emitting section 120 that receives the supply voltage Vo from the switching power supply section 110, causing the LEDs 121-1 to 121-n to be lit.

The switching section 130 is maintained OFF while the LED lighting-up signal LO is inactive low. At this time, the current ILED does not flow through the light-emitting section 120 that receives the supply voltage Vo from the switching power supply section 110, causing the LEDs 121-1 to 121-n to be unlit.

While the switching section 130 is ON, the voltage Vs of a connection node ND101 between the switching section 130 and constant current circuit 140 is basically as follows.

That is, the voltage Vs of the connection node ND101 is equal to the voltage obtained by subtracting the sum ΣVf (=VF) of the forward voltages Vf of all the LEDs 121-1 to 121-n of the light-emitting section 120 from the supply voltage Vo of the switching power supply section 110.

This voltage does not take into consideration the voltage drop across the switching section 130.

If the switching section 130 is formed with a field effect transistor (FET), the voltage of the node ND101 is equal to the voltage obtained by subtracting the sum VF of the forward voltages Vf of all the LEDs 121-1 to 121-n of the light-emitting section 120 and the drain-to-source voltage Vds of the FET from the supply voltage Vo.

The control circuit 150 includes an error amplifier 151, hold switch (SWhold) 152, soft switch (SWsoft) 153 and soft switching circuit 154.

The control circuit 150 also includes a comparator 155, pulse output flip-flop (FF) 156, clock generator 157, driver 158, reference voltage source V151, holding capacitor C151 and terminals T111, T112 and T113.

The comparator 155, FF 156 and clock generator 157 make up a pulse converter 159.

The terminal T111 is connected to the connection node ND101 between the switching section 130 and constant current circuit 140. The terminal T112 is connected to the node ND113 of the switching power supply section 110. The terminal T113 is connected to the gate of the switching transistor SW111.

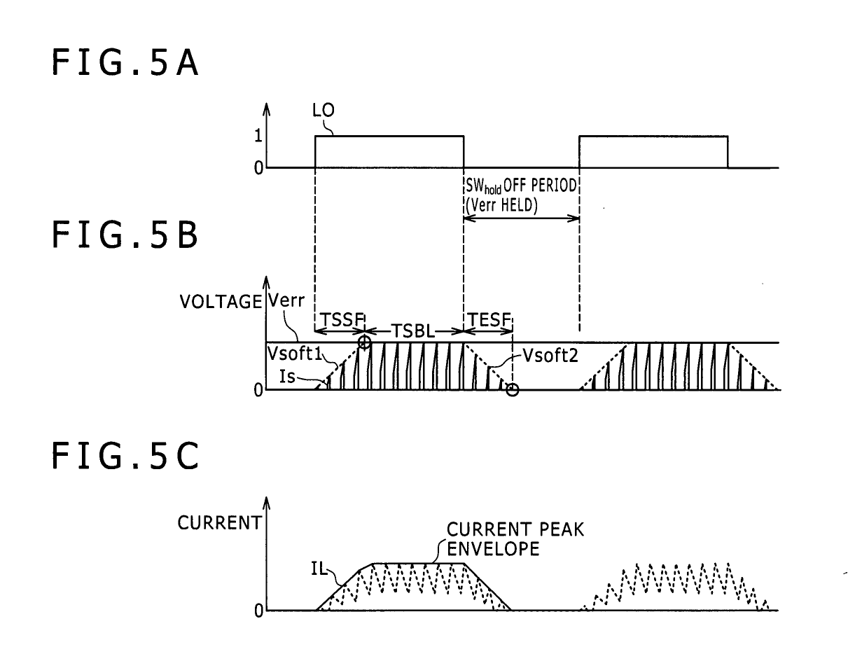

FIGS. 5A to 5C are diagrams illustrating major waveforms of the switching power supply section of the LED driver according to the present embodiment during control.

FIG. 5A illustrates the waveform of the LED lighting-up signal LO, FIG. 5B the waveforms of the error voltage Verr and the current Is of the node ND113, and FIG. 5C the waveform of the current IL flowing through the inductor L111 together with its peak envelope waveform.

The error amplifier 151 has its non-inverted input terminal (+) connected to the reference voltage source V151 and its inverted input terminal (−) connected to the terminal T111 to which the voltage Vs of the node ND101 is supplied.

The error amplifier 151 amplifies the voltage difference between the voltage Vs of the node ND101 and the reference voltage Vref and outputs the error voltage Verr to the hold switch 152. This voltage Verr is held by the capacitor C151 while the hold switch 152 is OFF.

The hold switch 152 has its terminal ‘a’ connected to the output of the error amplifier 151 and its terminal ‘b’ connected to one terminal of the capacitor C151, one input of the soft switching circuit 154 and one terminal of the soft switch 153. These connection points make up a node ND151.

The hold switch 152 conducts between its terminals ‘a’ and ‘b’ when the LED lighting-up signal LO is active. The hold switch 152 does not conduct therebetween when the LED lighting-up signal LO is inactive.

When the hold switch 152 conducts, the error voltage Verr generated by the error amplifier 151 is fed to the capacitor C151, soft switching circuit 154 and soft switch 153.

The soft switch 153 has its terminal ‘a’ connected to the node ND151 to which the terminal ‘b’ of the hold switch 152, for example, is connected. The same switch 153 has its terminal ‘b’ connected to the supply line of a soft voltage Vsoft of the soft switching circuit 154. The same switch 153 has its terminal ‘c’ connected to the inverted input terminal (−) of the comparator 155.

The soft switch 153 conducts between its terminals ‘a’ and ‘c’ when a switching signal SWSF of the soft switching circuit 154 is, for example, low (or high) and conducts between its terminals ‘b’ and ‘c’ when the switching signal SWSF is, for example, high (or low).

The switching signal SWSF is low during a soft start period (first period) TSSF starting from the leading edge of the LED lighting-up signal LO or during a soft end period (second period) TESF starting from the trailing edge of the LED lighting-up signal LO.

Here, the term “soft start period (first period) TSSF” refers to a period during which the soft voltage Vsoft increases gradually with time from the reference potential VSS to the error voltage Verr.

The term “soft end period (second period) TESF” refers to a period during which the soft voltage Vsoft decreases gradually with time from the error voltage Verr to the reference potential VSS.

The soft switch 153 supplies the soft voltage Vsoft, generated by the soft switching circuit 154, to the comparator 155 during the soft start period (first period) TSSF and soft end period (second period) TESF.

The soft switch 153 supplies the error voltage Verr, output from the error amplifier 151, to the comparator 155 during a stable period TSBL other than the soft start period (first period) TSSF and soft end period (second period) TESF.

When supplied with the LED lighting-up signal LO at active high level, the soft switching circuit 154 outputs a first soft voltage Vsoft1 that increases gradually with time from the reference potential VSS starting from the leading edge of the LED lighting-up signal LO to the error voltage Verr during the soft start period TSSF.

The soft switching circuit 154 outputs a second soft voltage Vsoft2 that decreases gradually with time from the error voltage Verr starting from the trailing edge of the LED lighting-up signal LO to the reference potential VSS during the soft end period TESF.

When supplied with the LED lighting-up signal LO at low level, the soft switching circuit 154 outputs a clear signal SCL at high level to a clear terminal CL of the FF 156 starting from the trailing edge of the LED lighting-up signal LO until the second soft voltage Vsoft2 reaches the reference potential VSS where the output of the same voltage Vsoft2 is terminated.

The soft switching circuit 154 outputs the clear signal SCL at low level to the clear terminal CL of the FF 156 when the second soft voltage Vsoft2 reaches the reference potential VSS where the output of the same voltage Vsoft2 is terminated.

The soft switching circuit 154 outputs the switching signal SWSF, for example, at low level to the soft switch 153 during the soft start period TSSF in which the first soft voltage Vsoft1 is output and during the soft end period TESF in which the second soft voltage Vsoft2 is output.

The soft switching circuit 154 outputs the switching signal SWSF at high level to the soft switch 153 during the stable period TSBL other than the soft start period TSSF and soft end period TESF.

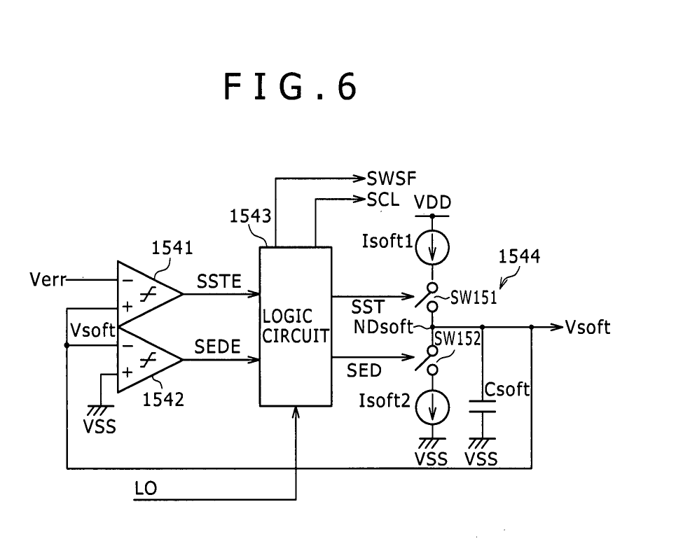

FIG. 6 is a diagram illustrating a configuration example of the soft switching circuit according to the present embodiment.

The soft switching circuit 154 shown in FIG. 6 includes comparators 1541 and 1542, logic circuit 1543 and soft voltage output section 1544.

The comparator 1541 compares the error voltage Verr and the soft voltage Vsoft output from the soft voltage output section 1544 and outputs a soft start end signal SSTE at low level to the logic circuit 1543 when the error voltage Verr is higher than the soft voltage Vsoft.

The comparator 1541 compares the error voltage Verr and the soft voltage Vsoft and outputs the soft start end signal SSTE at high level to the logic circuit 1543 when the soft voltage Vsoft increases to or beyond the error voltage Verr.

In other words, the comparator 1541 outputs the soft start end signal SSTE at low level during the soft start period (first period) TSSF in which the soft voltage Vsoft increases gradually with time from the reference potential VSS to the error voltage Verr.

The comparator 1542 compares the reference potential VSS and the soft voltage Vsoft output from the soft voltage output section 1544 and outputs a soft end signal SEDE at low level to the logic circuit 1543 when the soft voltage Vsoft is higher than the reference potential VSS.

The comparator 1542 outputs the soft end signal SEDE at high level to the logic circuit 1543 when the soft voltage Vsoft drops to the reference potential VSS.

In other words, the comparator 1542 outputs the soft end signal SEDE at low level during the soft end period (second period) TESF in which the soft voltage Vsoft decreases gradually with time from the error voltage Verr to the reference potential VSS.

When supplied with the LED lighting-up signal LO at active high level, the logic circuit 1543 performs the following processes.

The logic circuit 1543 outputs the clear signal SCL at high level to the negative clear terminal CL of the FF 156. At this time, the FF 156 remains uncleared.

The logic circuit 1543 outputs the clear signal SCL at low level to the negative clear terminal CL of the FF 156 when the soft end period TESF ends. At this time, the FF 156 is cleared.

The logic circuit 1543 performs the following processes when the LED lighting-up signal LO is active high.

When the soft start end signal SSTE and soft end signal SEDE are low, the logic circuit 1543 determines that the soft start period TSSF is in progress and outputs the switching signal SWSF at high level to the soft switch 153.

At this time, the soft switch 153 conducts between its terminals ‘b’ and ‘c,’ supplying the first soft voltage Vsoft1 to the comparator 155.

Further, when determining that the soft start period TSSF is in progress, the logic circuit 1543 outputs a soft start signal SST, for example, at low level and a soft end signal SED at low level to the soft voltage output section 1544. The soft start signal SST is output, for example, at low level because it is assumed that the switch of the soft voltage output section 1544 is formed with a PMOS transistor. The soft start signal SST is output at high level if the switch thereof is formed with an NMOS transistor. The soft end signal SED is output at low level because it is assumed that the associated switch is formed with an NMOS transistor.

At this time, the soft voltage output section 1544 outputs the first soft voltage Vsoft1 that increases gradually with time from the reference potential VSS to the error voltage Verr during the soft start period TSSF.

The logic circuit 1543 performs the following processes when the LED lighting-up signal LO is active high.

When the soft start end signal SSTE is high and the soft end signal SEDE is low, the logic circuit 1543 determines that the stable period TSBL is in progress and outputs the switching signal SWSF at low level to the soft switch 153.

At this time, the soft switch 153 conducts between its terminals ‘a’ and ‘c,’ supplying the error voltage Verr to the comparator 155.

Further, when determining that the stable period TSBL is in progress, the logic circuit 1543 outputs the soft start signal SST at high level and the soft end signal SED at low level to the soft voltage output section 1544.

At this time, the soft voltage output section 1544 holds the output of the first soft voltage Vsoft1 or second soft voltage Vsoft2.

The logic circuit 1543 is triggered by the trailing edge of the LED lighting-up signal LO from active high to low level to perform the following processes.

At this time, when the soft start end signal SSTE is high and the soft end signal SEDE is low, the logic circuit 1543 determines that the soft end period TESF is in progress and outputs the switching signal SWSF at high level to the soft switch 153.

At this time, the soft switch 153 conducts between its terminals ‘b’ and ‘c,’ supplying the second soft voltage Vsoft2 to the comparator 155.

Further, when determining that the soft end period TESF is in progress, the logic circuit 1543 outputs the soft start signal SST at high level and the soft end signal SED at high level to the soft voltage output section 1544.

At this time, the soft voltage output section 1544 outputs the second soft voltage Vsoft2 that decreases gradually with time from the error voltage Verr to the reference potential VSS during the soft end period TESF.

The soft voltage output section 1544 includes an output node NDsoft, current source Isoft1 and switch SW151. The current source Isoft1 and switch SW151 are connected in series between the power supply VDD and output node NDsoft.

The soft voltage output section 1544 further includes a switch SW152 and current source Isoft2 that are connected in series between the output node NDsoft and reference potential VSS (e.g., ground potential).

The soft voltage output section 1544 still further includes a capacitor Csoft connected between the output node NDsoft and reference potential VSS.

When the soft voltage output section 1544 is supplied with the soft start signal SST at low level and the soft end signal SED at low level from the logic circuit 1543, the switch SW151 turns ON, and the switch SW152 turns OFF.

In this case, the soft voltage output section 1544 determines that the soft start period TSSF is in progress and outputs, to the soft switch 153 and comparators 1541 and 1542, the first soft voltage Vsoft1 that increases gradually with time from the reference potential VSS to the error voltage Verr.

At this time, electric charge is stored in the capacitor Csoft.

When the soft voltage output section 1544 is supplied with the soft start signal SST at high level and the soft end signal SED at high level from the logic circuit 1543, the switch SW151 turns OFF, and the switch SW152 turns ON.

In this case, the soft voltage output section 1544 determines that the soft end period TESF is in progress and outputs, to the soft switch 153 and comparators 1541 and 1542, the second soft voltage Vsoft2 that decreases gradually with time from the error voltage Verr to the reference potential VSS.

At this time, electric charge stored in the capacitor Csoft is discharged.

When the soft voltage output section 1544 is supplied with the soft start signal SST at low level and the soft end signal SED at low level from the logic circuit 1543, the switch SW151 turns OFF, and the switch SW152 turns OFF.

In this case, the soft voltage output section 1544 determines that the stable period TSBL is in progress and maintains the output node NDsoft in a high impedance state Hi-Z.

The comparator 155 has its non-inverted input terminal (+) connected to the terminal T112 and its inverted input terminal (−) connected to the terminal ‘c’ of the soft switch 153. The terminal T112 is connected to the node ND113 of the switching power supply section 110.

When the terminals ‘c’ and ‘a’ of the soft switch 153 are connected, the comparator 155 compares the error voltage Verr and a voltage (voltage obtained by converting the current Is with the resistor element R111) VN113 of the node ND113 and outputs the comparison result to the FF 156.

The comparator 155 outputs a low level signal when the voltage VN113 of the node ND113 is lower than the error voltage Verr and a high level signal when the voltage VN113 is higher than the error voltage Verr.

When the terminals ‘c’ and ‘b’ of the soft switch 153 are connected, the comparator 155 compares the first soft voltage Vsoft1 or second soft voltage Vsoft2 and the voltage VN113 of the node ND113 and outputs the comparison result to the FF 156.

The comparator 155 outputs a low level signal when the voltage VN113 of the node ND113 is lower than the first soft voltage Vsoft1 or second soft voltage Vsoft2 and a high level signal when the voltage VN113 is higher than the first soft voltage Vsoft1 or second soft voltage Vsoft2.

The FF 156 includes a set-reset (RS) FF.

The FF 156 is cleared when the clear signal SCL output from the soft switching circuit 154 is low. When the clear signal SCL is high, the FF 156 outputs a pulse from its terminal Q according to the level of the clock CLK supplied to its set terminal S and the level of the output signal from the comparator 155 supplied to its reset terminal RT.

As a result, the FF 156 outputs, to the driver 158, the signal PLS having a pulse width commensurate with the difference between the voltage Vs of the node ND101 and the reference voltage Vref.

This pulse signal. PLS is supplied to the gate of the switching transistor SW111 via the driver 158, allowing for the switching power supply section 110 to perform voltage boosting by controlling the switching transistor SW111 to turn ON and OFF.

A description will be given next of the operations of the LED driver 100 configured as described above with focus on the control operation of the control circuit 150.

The switching section 130 is maintained OFF when the LED lighting-up signal LO is inactive low. At this time, the current ILED does not flow through the light-emitting section 120 that receives the supply voltage Vo from the switching power supply section 110, causing the LEDs 121-1 to 121-n to be unlit.

While the switching section 130 is OFF, the voltage Vs of the connection node ND101 between the switching section 130 and constant current circuit 140 is basically at the reference potential (ground potential) level.

The hold switch 152 of the control circuit 150 is maintained OFF when the LED lighting-up signal LO is low. It should be noted, however, that the error voltage Verr prior to the turning-OFF of the switch 152 is held by the capacitor C151.

At this time, therefore, the error voltage Verr output from the error amplifier 151 of the control circuit 150 is at a constant level.

Further, at this time, the LED lighting-up signal LO changes to low level. Then, the soft end period TESF elapses, supplying the clear signal SCL at low level from the soft switching circuit 154 to the clear terminal CL of the FF 156.

Here, when the LED lighting-up signal LO rises to active high level, the switching section 130 turns ON. The switching section 130 is maintained ON while the LED lighting-up signal LO in a pulse form is active high.

At this time, the current ILED flows through the light-emitting section 120 that receives the supply voltage Vo from the switching power supply section 110, causing the LEDs 121-1 to 121-n to be lit.

While the switching section 130 is ON, the voltage Vs of the node ND101 between the switching section 130 and constant current circuit 140 is supplied to the error amplifier 151 of the control circuit 150. The voltage Vs is basically equal to the voltage obtained by subtracting the sum ΣVf (=VF) of the forward voltages Vf of all the LEDs 121-1 to 121-n of the light-emitting section 120 from the supply voltage Vo of the switching power supply section 110.

Further, when the LED lighting-up signal LO changes to high level, the hold switch 152 of the control circuit 150 turns ON, supplying the clear signal SCL at high level from the soft switching circuit 154 to the clear terminal CL of the FF 156 and causing the FF 156 to be uncleared.

Then, the error amplifier 151 amplifies the voltage difference between the voltage Vs of the node ND101 and the reference voltage Vref and outputs the error voltage Verr to the hold switch 152. This voltage Verr is held by the capacitor C151 while the hold switch 152 is OFF.

At this time, the hold switch 152 conducts, thus supplying the voltage Verr from the error amplifier 151 to the soft switching circuit 154 and the soft switch 153.

The soft switching circuit 154 compares the error voltage Verr and the soft voltage Vsoft to be output.

In this case, the above comparison is conducted immediately after the LED lighting-up signal LO rises to high level. Therefore, the soft voltage Vsoft is equal to the reference potential VSS, and the error voltage Verr is higher than the soft voltage Vsoft.

As a result, the soft switching circuit 154 outputs the switching signal SWSF at low level to the soft switch 153 to start the soft start period TSSF.

In response to the switching signal SWSF at low level, the terminals ‘c’ and ‘b’ of the soft switch 153 are connected, thus supplying the soft voltage Vsoft to the comparator 155.

Then, the soft switching circuit 154 generates the first soft voltage Vsoft1 that increases gradually with time from the reference potential VSS to the error voltage Verr during the soft start period TSSF starting from the leading edge of the LED lighting-up signal LO.

The first soft voltage Vsoft1 is supplied to the comparator 155 via the soft switch 153.

The comparator 155 compares the first soft voltage Vsoft1 and the voltage VN113 of the node ND113 and outputs the comparison result to the FF 156. The comparator 155 outputs a low level signal when the voltage VN113 of the node ND113 is lower than the first soft voltage Vsoft1 and a high level signal when the voltage VN113 is higher than the first soft voltage Vsoft1.

The FF 156 outputs a pulse from its terminal Q to the driver 158 according to the level of the clock CLK supplied to its set terminal S and the level of the output signal from the comparator 155 supplied to its reset terminal RT. As a result, the FF 156 outputs, to the driver 158, the signal PLS having a pulse width commensurate with the difference between the voltage Vs of the node ND101 and the reference voltage Vref.

Then, this pulse signal PLS is supplied to the gate of the switching transistor SW111 via the driver 158, allowing for the switching power supply section 110 to perform voltage boosting by controlling the switching transistor SW111 to turn ON and OFF.

At this time, the current IL (Is) flowing through the inductor L111 of the switching power supply section 110 increases gradually from the start to end of the soft start period TSSF.

In the switching power supply section 110, the switching transistor SW111 is controlled to turn ON and OFF by a PWM-controlled pulse signal of the control circuit 150, thus boosting the voltage VDD of the constant voltage source V111 and supplying the boosted voltage to one end of the light-emitting section 120.

The soft switching circuit 154 compares the error voltage Verr and the first soft voltage Vsoft1 being output. When the first soft voltage Vsoft1 reaches the level of the error voltage Verr, the soft switching circuit 154 determines that the soft start period TSSF ends and the stable period TSBL begins.

As a result, the soft switching circuit 154 outputs the switching signal SWSF at high level to the soft switch 153 to start the stable period TSBL.

In response to the switching signal SWSF at high level, the terminals ‘c’ and ‘a’ of the soft switch 153 are connected, thus supplying the error voltage Verr to the comparator 155.

Then, the soft switching circuit 154 stops the output of the soft voltage Vsoft.

The comparator 155 compares the error voltage Verr and the voltage VN113 of the node ND113 and outputs the comparison result to the FF 156. The comparator 155 outputs a low level signal when the voltage VN113 of the node ND113 is lower than the error voltage Verr and a high level signal when the voltage VN113 is higher than the error voltage Verr.

The FF 156 outputs a pulse from its terminal Q to the driver 158 according to the level of the clock CLK supplied to its set terminal S and the level of the output signal from the comparator 155 supplied to its reset terminal RT. As a result, the FF 156 outputs, to the driver 158, the signal PLS having a pulse width commensurate with the difference between the voltage Vs of the node ND101 and the reference voltage Vref.

Then, this pulse signal PLS is supplied to the gate of the switching transistor SW111 via the driver 158, allowing for the switching power supply section 110 to perform voltage boosting by controlling the switching transistor SW111 to turn ON and OFF.

In the switching power supply section 110, the switching transistor SW111 is controlled to turn ON and OFF by a PWM-controlled pulse signal of the control circuit 150, thus boosting the voltage VDD of the constant voltage source V111 and supplying the boosted voltage to one end of the light-emitting section 120 that serves as a load.

Here, when the LED lighting-up signal LO falls to low level, the hold switch 152 of the control circuit 150 turns OFF, supplying the error voltage Verr held by the capacitor C151 to the soft switching circuit 154.

When supplied with the LED lighting-up signal LO at low level during the stable period TSBL, the soft switching circuit 154 outputs the switching signal SWSF at low level to the soft switch 153 to start the soft end period TESF.

In response to the switching signal SWSF at low level, the terminals ‘c’ and ‘b’ of the soft switch 153 are connected, thus supplying the soft voltage Vsoft to the comparator 155.

Then, the soft switching circuit 154 generates the second soft voltage Vsoft2 that decreases gradually with time from the error voltage Verr to the reference potential VSS during the soft end period TESF starting from the trailing edge of the LED lighting-up signal LO.

The second soft voltage Vsoft2 is supplied to the comparator 155 via the soft switch 153.

The comparator 155 compares the second soft voltage Vsoft2 and the voltage VN113 of the node ND113 and outputs the comparison result to the FF 156. The comparator 155 outputs a low level signal when the voltage VN113 of the node ND113 is lower than the second soft voltage Vsoft2 and a high level signal when the voltage VN113 is higher than the second soft voltage Vsoft2.

The FF 156 outputs a pulse from its terminal Q to the driver 158 according to the level of the clock CLK supplied to its set terminal S and the level of the output signal from the comparator 155 supplied to its reset terminal RT. As a result, the FF 156 outputs, to the driver 158, the signal PLS having a pulse width commensurate with the difference between the voltage Vs of the node ND101 and the reference voltage Vref.

Then, this pulse signal PLS is supplied to the gate of the switching transistor SW111 via the driver 158, allowing for the switching power supply section 110 to perform voltage boosting by controlling the switching transistor SW111 to turn ON and OFF.

At this time, the current IL (Is) flowing through the inductor L111 of the switching power supply section 110 decreases gradually from the start to end of the soft end period TESF.

In the switching power supply section 110, the switching transistor SW111 is controlled to turn ON and OFF by a PWM-controlled pulse signal of the control circuit 150, thus boosting the voltage VDD of the constant voltage source V111 and supplying the boosted voltage to one end of the light-emitting section 120.

As described above, in the first embodiment, the control circuit 150 generates the first soft voltage Vsoft1 that increases gradually with time from the reference potential VSS to the error voltage Verr during the soft start period TSSF starting from the leading edge of the LED lighting-up signal LO.

Further, the control circuit 150 generates the second soft voltage Vsoft2 that decreases gradually with time from the error voltage Verr to the reference potential VSS during the soft end period TESF starting from the trailing edge of the LED lighting-up signal LO.

Still further, the control circuit 150 controls the switching transistor SW111 to turn ON and OFF based on the first soft voltage Vsoft1 that increases gradually with time from the reference potential VSS to the error voltage Verr during the soft start period TSSF.

As a result, the current IL (Is) flowing through the inductor L111 of the switching power supply section 110 is controlled so as to increase gradually from the start to end of the soft start period TSSF.

The control circuit 150 controls the switching transistor SW111 to turn ON and OFF based on the second soft voltage Vsoft2 that decreases gradually with time from the error voltage Verr to the reference potential VSS during the soft end period TESF.

As a result, the current IL (Is) flowing through the inductor L111 of the switching power supply section 110 is controlled so as to decrease gradually from the start to end of the soft end period TESF.

Therefore, the present first embodiment provides the following advantageous effects.

That is, in the LED driver 100 according to the present embodiment, the change in the current IL flowing through the inductor L111 is small immediately after the LEDs of the light-emitting section 120 light up and when the LEDs go out.

In general, magnetic components such as transformers and choke coils, and capacitors used for power supplies vibrate in principle at the frequency of the current or voltage applied thereto.

However, the change in the current IL is kept small as in the LED driver 100 according to the present embodiment. This suppresses audible abnormal noise from these components and prevents abnormal heating of these components due to rush current.

### 2. Second Embodiment

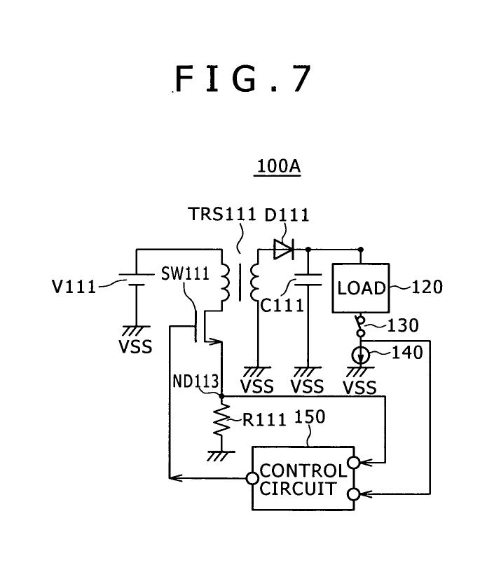

FIG. 7 is a block diagram illustrating a configuration example of the light-emitting element (LED) driver according to a second embodiment of the present invention.

An LED driver 100A according to the second embodiment differs from the LED driver 100 according to the first embodiment in the following respects.

The power supply section 110 of the LED driver 100 according to the first embodiment is configured as a current mode boost chopper.

In contrast, a power supply section 110A of the LED driver 100A according to the second embodiment is configured as a current mode flyback converter using a transformer TRS111.

The LED driver 100A according to the second embodiment is identical to the counterpart according to the first embodiment in all other respects.

The second embodiment provides the same advantageous effects as the first embodiment.

The LED drivers 100 and 100A according to the present embodiments are, for example, suitable for use in a transmissive liquid crystal display device having a backlight device.

### 3. Third Embodiment

A description will be given below of a liquid crystal display device having an LED backlight as a third embodiment of the present invention to which any of the LED drivers shown in FIGS. 3 to 7 is applicable.

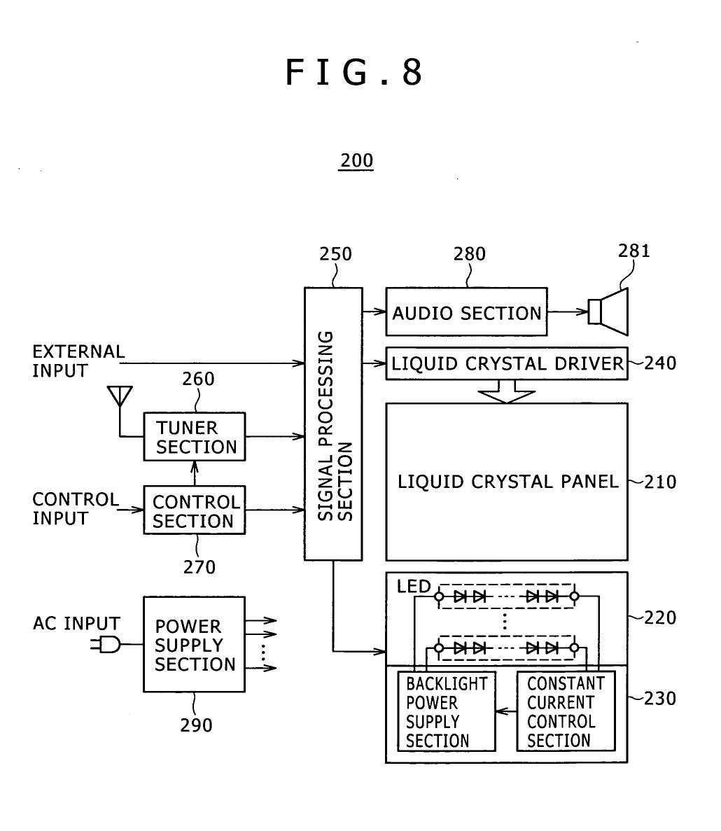

FIG. 8 is a block diagram illustrating a configuration example of the liquid crystal display device according to the third embodiment of the present invention.

A liquid crystal display device 200 includes a transmissive liquid crystal display panel (LCD panel) 210, backlight device 220, LED driver 230 and liquid crystal driver (panel drive circuit) 240 as illustrated in FIG. 8. The backlight device 220 is provided at the back of the LCD panel 210 to serve as an illumination unit.

The liquid crystal display device 200 also includes a signal processing section 250, tuner section 260, control section 270, audio section 280 and power supply section 290. The audio section 280 includes a speaker 281.

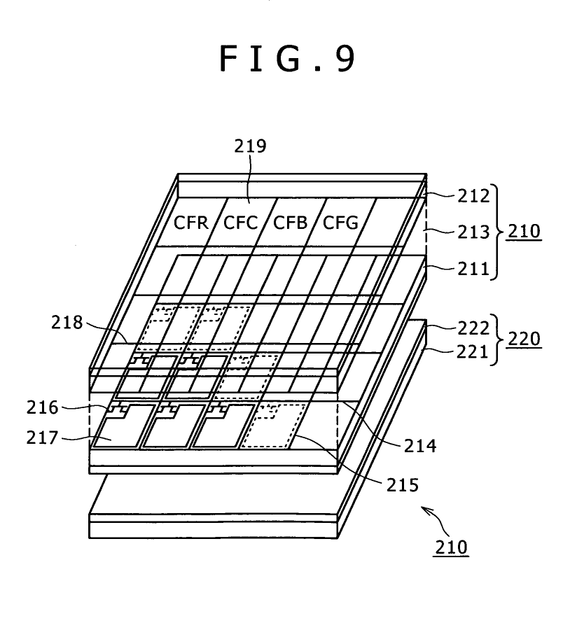

FIG. 9 is a diagram illustrating a configuration example of the transmissive LCD panel 210.

The transmissive LCD panel 210 includes a TFT substrate 211 and opposed electrode substrate 212 that are opposed to each other. A liquid crystal layer 213 is provided in the gap between the two substrates. A twisted nematic (TN) liquid crystal, for example, is sealed in the liquid crystal layer 213.

Signal lines 214 and scan lines 215 are formed in a matrix manner on the TFT substrate 211. Further, thin film transistors 216 and pixel electrodes 217 are provided at the intersections between the signal lines 214 and scan lines 215. The thin film transistors 216 serve as switching elements.

The thin film transistors 216 are selected in sequence by the scan lines 215, and video signals supplied from the signal lines 214 are written to the associated pixel electrodes 217. On the other hand, opposed electrodes 218 and color filters 219 are formed on the inner surface of the opposed electrode substrate 212.

In the liquid crystal display device 200, the transmissive LCD panel 210 configured as described above is sandwiched between two polarizers and active-matrix-driven with white light irradiated by the backlight device 220 from the back, thus providing a desired full color image.

The backlight device 220 includes a light source 221 and wavelength selection filter 222.

The light source 221 includes a plurality of LED arrays that form the light-emitting section 120 to be driven in the first and second embodiments.

The backlight device 220 illuminates the LCD panel 210 from the back via the wavelength selection filter 222 using light emitted from the light source 221.

The backlight device 220 illustrated in FIG. 9 is an example of a direct type backlight device disposed on the rear of the transmissive LCD panel 210 and adapted to illuminate the same panel 210 from the back and immediately below the same panel 210.

As described above, the light source (light-emitting section) 221 of the backlight device 220 uses a plurality of LEDs connected in series as its light source.

The light source 221 of the backlight device 220 includes a plurality of LED arrays (group of LEDs). In each of these LED arrays, the LEDs arranged horizontally on the screen are connected in series.

The backlight device 220 configured as described above is driven by the LED driver 230.

Any of the LED drivers described above with reference to FIGS. 3 to 7 is applicable as the LED driver 230.

Although FIG. 9 shows as if the light source 221 as a whole is driven by the LED driver 230, an independent LED driver may be provided for each of the LED arrays connected horizontally in series.

The liquid crystal driver 240 includes, for example, X and Y driver circuits, and drives the LCD panel 210 using, for example, an RGB separate signal supplied from the signal processing section 250 to the X and Y driver circuits.

This allows for an image commensurate with the RGB separate signal to be displayed.

The signal processing section 250 subjects the video signal supplied from the tuner section 260 or external equipment to signal processing such as chroma processing and further converts the composite signal into an RGB separate signal suited to driving the LCD panel 210, thus supplying the RGB separate signal to the panel drive circuit 240.

On the other hand, the signal processing section 250 extracts an audio signal from the input signal and transmits the audio signal to the speaker 281 via the audio section 280 to produce a sound.

In the liquid crystal display device 200 configured as described above, the LED driver 100 or 100A shown in FIGS. 3 to 7 is used.

Therefore, the change in the current IL flowing through the inductor L111 is small immediately after the LEDs of the backlight device 220 light up and when the LEDs go out.

This keeps the change in the current IL flowing through the inductor IL to a minimum, thus suppressing audible abnormal noise from these components and preventing abnormal heating of the components due to rush current.

The present application contains subject matter related to that disclosed in Japanese Priority Patent Application JP 2010-115237 filed in the Japan Patent Office on May 19, 2010, the entire content of which is hereby incorporated by reference.

It should be understood by those skilled in the art that various modifications, combinations, sub-combinations and alternations may occur depending on design requirements and other factors insofar as they are within the scope of the appended claims or the equivalent thereof.

What is claimed is:

1. A light-emitting element driver comprising:
a light-emitting section including at least one light-emitting element adapted to emit light at the luminance commensurate with the current flowing therethrough;
a power supply section that is adjustable in output voltage according to the signal fed to the control terminal of a switching element and that supplies an output voltage to one end of the light-emitting section;
a switching section connected between each of other ends of the light-emitting section and a reference potential and controlled to conduct or block current by a lighting-up signal in a pulse form;
a constant current circuit or resistor connected between the other end of the light-emitting section and the reference potential so as to be in series with the switching section; and
a control circuit adapted to obtain an error voltage between a connection terminal voltage between the switching section and constant current circuit and the preset reference voltage and output, to the control terminal of the switching element, a signal having a pulse width causing a current proportional to the error voltage to flow through the switching element, wherein
at least either during a soft start period starting from the leading edge of the lighting-up signal or during a soft end period starting from the trailing edge of the lighting-up signal, the control circuit outputs, to the control terminal of the switching element, a signal having a pulse width causing a current proportional to a soft voltage rather than the error voltage to flow through the switching element, the soft voltage increasing from the reference potential with time or decreasing from the error voltage with time.

2. The light-emitting element driver of claim 1, wherein
during the soft start period starting from the leading edge of the lighting-up signal, the control circuit outputs, to the control terminal of the switching element, a signal having a pulse width causing a current proportional to a first soft voltage to flow through the switching element, the first soft voltage increasing gradually with time from the reference potential to the error voltage.

3. The light-emitting element driver of claim 1, wherein
during the soft end period starting from the trailing edge of the lighting-up signal, the control circuit outputs, to the control terminal of the switching element, a signal having a pulse width causing a current proportional to a second soft voltage to flow through the switching element, the second soft voltage decreasing gradually with time from the error voltage to the reference potential.

4. The light-emitting element driver of claim 1, wherein
during the soft start period starting from the leading edge of the lighting-up signal, the control circuit outputs, to the control terminal of the switching element, a signal having a pulse width causing a current proportional to the first soft voltage to flow through the switching element, the first soft voltage increasing gradually with time from the reference potential to the error voltage,
during a stable period following the soft start period, the control circuit outputs, to the control terminal of the switching element, a signal having a pulse width causing a current proportional to the error voltage rather than the first soft voltage to flow through the switching element, and
when the lighting-up signal falls in level during the stable period, the control circuit outputs, to the control terminal of the switching element, a signal having a pulse width causing a current proportional to the second soft voltage rather than the error voltage to flow through the switching element during the soft end period starting from the trailing edge of the lighting-up signal, the second soft voltage decreasing gradually with time from the error voltage to the reference potential.

5. The light-emitting element driver of claim 1, wherein
the power supply section is formed with a switching power supply that includes an inductor or transformer, capacitor and switching transistor and whose output voltage is adjusted by turning the switching transistor ON and OFF.

6. A display device comprising:
a transmissive display section;
an illumination unit including a light-emitting section including at least one light-emitting element adapted to emit light at the luminance commensurate with the current flowing therethrough, the illumination unit being adapted to irradiate the transmissive display section with emitted light; and
a light-emitting element driver adapted to drive the light-emitting element of the light-emitting section,
the light-emitting element driver including
a power supply section that is adjustable in output voltage according to the signal fed to the control terminal of a switching element and that supplies an output voltage to one end of the light-emitting section,
a switching section connected between each of other ends of the light-emitting section and a reference potential and controlled to conduct or block current by a lighting-up signal in a pulse form,
a constant current circuit or resistor connected between the other end of the light-emitting section and the reference potential so as to be in series with the switching section, and
a control circuit adapted to obtain an error voltage between a connection terminal voltage between the switching section and constant current circuit and the preset reference voltage and output, to the control terminal of the switching element, a signal having a pulse width causing a current proportional to the error voltage to flow through the switching element, wherein
at least either during a soft start period starting from the leading edge of the lighting-up signal or during a soft end period starting from the trailing edge of the lighting-up signal, the control circuit outputs, to the control terminal of the switching element, a signal having a pulse width causing a current proportional to a soft voltage rather than the error voltage to flow through the switching element, the soft voltage increasing from the reference potential with time or decreasing from the error voltage with time.

7. The display device of claim 6, wherein
during the soft start period starting from the leading edge of the lighting-up signal, the control circuit outputs, to the control terminal of the switching element, a signal having a pulse width causing a current proportional to a first soft voltage to flow through the switching element, the first soft voltage increasing gradually with time from the reference potential to the error voltage.

8. The display device of claim 6, wherein
during the soft end period starting from the trailing edge of the lighting-up signal, the control circuit outputs, to the control terminal of the switching element, a signal having a pulse width causing a current proportional to a second soft voltage to flow through the switching element, the second soft voltage decreasing gradually with time from the error voltage to the reference potential.

9. The display device of claim 6, wherein
during the soft start period starting from the leading edge of the lighting-up signal, the control circuit outputs, to the control terminal of the switching element, a signal having a pulse width causing a current proportional to the first soft voltage to flow through the switching element, the first soft voltage increasing gradually with time from the reference potential to the error voltage,
during a stable period following the soft start period, the control circuit outputs, to the control terminal of the switching element, a signal having a pulse width causing a current proportional to the error voltage rather than the first soft voltage to flow through the switching element, and
when the lighting-up signal falls in level during the stable period, the control circuit outputs, to the control terminal of the switching element, a signal having a pulse width causing a current proportional to the second soft voltage rather than the error voltage to flow through the switching element during the soft end period starting from the trailing edge of the lighting-up signal, the second soft voltage decreasing gradually with time from the error voltage to the reference potential.

10. The display device of claim 6, wherein
the power supply section is formed with a switching power supply that includes an inductor or transformer, capacitor and switching transistor and whose output voltage is adjusted by turning the switching transistor ON and OFF.
